(19) United States
(12) Patent Application Publication
(10) Pub. No.: US 2014/0201657 A1
(43) Pub. Date: Jul. 17, 2014

(54) METHOD AND APPARATUS FOR RECEIVING INPUT OF VARYING LEVELS OF COMPLEXITY TO PERFORM ACTIONS HAVING DIFFERENT SENSITIVITIES

(71) Applicant: MOTOROLA MOBILITY LLC, Libertyville, IL (US)

(72) Inventor: Fabio Seitoku Nagamine, Sumare (BR)

(73) Assignee: MOTOROLA MOBILITY LLC, Libertyville, IL (US)

(21) Appl. No.: 13/741,422

(22) Filed: Jan. 15, 2013

(51) Int. Cl. G06F 3/0484

(52) U.S. Cl. CPC G06F 3/04847
USPC 715/766

(57) ABSTRACT

A method and apparatus for receiving input of varying levels of complexity to perform actions having different sensitivities includes associating a first action having a high first sensitivity with a high first level of user input and animation sequence complexity; and associating a second action having a low second sensitivity with a low second level of user input and animation sequence complexity. The method further includes presenting, on an interface of the apparatus, an initial animation associated with the first action; receiving, in connection with the initial animation, a first user input that causes the generation, on the interface, of a first animation sequence that tracks the first user input, wherein the first animation sequence begins with the initial animation; and monitoring the first user input to determine whether the first user input meets the first level of user input and animation sequence complexity.

### FIELD OF THE DISCLOSURE

The present disclosure relates generally to performing tasks on a computerized device and more particularly to associating user inputs of different relative complexity with performing tasks of different relative sensitivity.

### BACKGROUND

Modern-day computerized devices, such as cell phones and laptops, are feature rich in that they can perform a wide variety of actions or tasks. This increases the utility of these devices and allows for diverse patterns of usage. While users have access to all aspects of a device's functionality, each will typically be familiar with only a subset of available features, specifically, those they commonly use. Thus, a certain level of uncertainty is involved when a user finds himself overseeing actions with which he is unfamiliar. A device seeking confirmation that a specific entry should be deleted from its registry, for example, might give a casual user pause, especially if he does not fully understand how sensitive such an action is in terms of how it will affect the operation of the device.

Experienced users can also unintentionally cause undesired actions to be performed on computerized devices. The methods of operation for many computerized devices, such as menu-driven devices, for example, have a high degree of similarity across devices. Even actions on a single device are often associated with the same input, typically designed to be “quick and easy.” This gives a user adept at one device the ability to more readily operate another. While the learning curve for a device is reduced under such circumstances, a high degree of redundancy makes it increasingly likely that a user will inadvertently initiate an undesired action. For example, a user might quickly click on a confirmation button out of muscle memory without taking the time to appreciate the nature of the input.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a computerized device having a touch-screen output and input interface implementing embodiments of the present teachings.

FIG. 2 is a logical flowchart of a method for associating inputs of various levels of complexity with actions having different sensitivities in accordance with some embodiments of the present teachings.

FIG. 3 is a schematic diagram of two temporal animation sequences with different levels of complexity in accordance with some embodiments of the present teachings.

FIG. 4 is a schematic diagram of two spatial animation sequences with different levels of complexity in accordance with some embodiments of the present teachings.

FIG. 5 is a schematic diagram of two hybrid animation sequences with different levels of complexity in accordance with some embodiments of the present teachings.

FIG. 6 is a schematic diagram illustrating a return to a pre-animation state for a spatial animation sequence in accordance with some embodiments of the present teachings.

FIG. 7 is a schematic diagram illustrating a computerized device presenting sensory accompaniment in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for receiving input of varying levels of complexity to perform actions having different sensitivities. Coupling more-sensitive actions performed on a computerized device with input of a higher degree of complexity greatly reduces the chance a user will initiate such an action inadvertently. In accordance with the teachings herein a method performed by a computerized device for receiving input of varying levels of complexity to perform actions having different sensitivities comprises: associating a first action having a first sensitivity with a first level of user input and animation sequence complexity; and associating a second action having a second sensitivity with a second level of user input and animation sequence complexity, wherein the second sensitivity is lower than the first sensitivity, and the first level of user input and animation sequence complexity is greater than the second level of user input and animation sequence complexity. The method further comprises: presenting, on an interface of the computerized device, an initial animation associated with the first action; receiving, in connection with the initial animation, a first user input that causes the generation, on the interface, of a first animation sequence that tracks the first user input, wherein the first animation sequence begins with the initial animation; and monitoring the first user input to determine whether the first user input meets the first level of user input and animation sequence complexity.

Also in accordance with the teachings herein is a method performed by a computerized device for associating actions having different levels of importance with input having varying degrees of complexity comprising: associating a first action having a first level of importance with a first degree of user input and animation sequence complexity; and associating a second action having a second level of importance with a second degree of user input and animation sequence complexity, wherein the first level of importance is greater than the second level of importance, and the first degree of user input and animation sequence complexity is greater than the second degree of user input and animation sequence complexity. The method further comprises: presenting, on an interface of the computerized device, an initial animation associated with the first action; receiving, in connection with the initial animation, a first user input that causes a first animation sequence to begin from the initial animation; and monitoring, as the first animation sequence is presented, the first user input to determine whether the first user input satisfies the first degree of user input and animation sequence complexity. Additionally, the method comprises confirming that the first user input satisfies the first degree of user input and animation sequence complexity, and responsively performing the first action.

In an embodiment, confirming that the first user input satisfies the first degree of user input and animation sequence complexity comprises at least one of: confirming that the first user input is sustained for a first threshold time that is greater than a second threshold time used to confirm that a second user input satisfies the second degree of user input and animation sequence complexity; or confirming that the first user input traverses a distance greater than a first threshold distance that exceeds a second threshold distance used to confirm that a second user input satisfies the second degree of user input and animation sequence complexity.

Further in accordance with the teachings herein, is an apparatus for accepting inputs with different relative complexities to perform tasks with different relative sensitivities comprising a processing element configured to: associate a first action having a first sensitivity with a first level of user input and animation sequence complexity; associate a second action having a second sensitivity with a second level of user input and animation sequence complexity, wherein the second sensitivity is lower than the first sensitivity, and the first level of user input and animation sequence complexity is greater than the second level of user input and animation sequence complexity; and monitor a first user input to determine whether the first user input satisfies the first level of user input and animation sequence complexity. The apparatus additionally comprises: an output interface coupled to the processing element and configured to display an initial animation and a first animation sequence associated with the first action; and an input interface coupled to the processing element and the output interface, wherein the input interface is configured to receive, in connection with the initial animation, a first user input that causes the generation, on the interface, of the first animation sequence that tracks the first user input, wherein the first animation sequence begins with the initial animation.

For an embodiment, the output interface is further configured to present a first sensory accompaniment with the first animation sequence, wherein the first sensory accompaniment has a greater prominence than a second sensory accompaniment presented with a second animation sequence associated with the second action, and wherein the processing element is further configured to perform the first action upon determining that the first user input satisfies the first level of user input and animation sequence complexity.

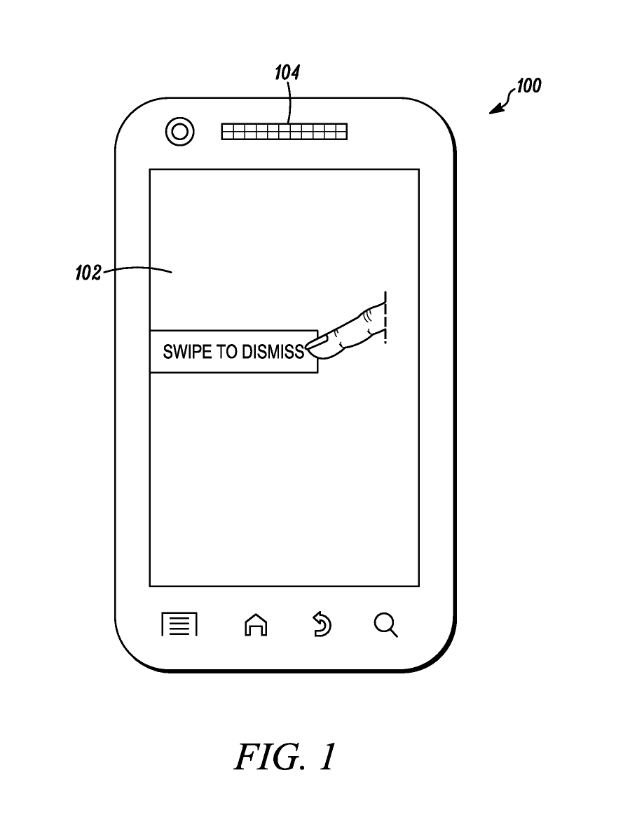

Referring now to the drawings, and in particular FIG. 1, a computerized device (also referred to herein simply as a “device”) implementing embodiments in accordance with the present teachings is shown and indicated generally at 100. Specifically, device 100 represents a cellular telephone with an output interface and an input interface that comprise a touch screen 102. The touch screen 102 operates as an input interface in that it can register tactile input provided by a user (referred to herein as “user input,” or simply as “input”). Different embodiments utilize different implements to generate tactile input, such as a stylus or a user's finger, for example. The touch screen 102 operates as an output interface by possessing the ability to display text and visual graphics. The device 100 can also generate audio output by using an integrated speaker, which is indicated at 104. Internal to the device 100 is a processing element (not shown) that is configured to process tactile input with different levels of complexity, and to associate the input with actions performed by the device 100 having different degrees of sensitivity. Only a limited number of elements are shown for ease of illustration, but additional such elements may be included in the device 100. Moreover, other components needed for a commercial embodiment of the device 100 are omitted for clarity in describing the enclosed embodiments.

While a cellular telephone is shown at 100, no such restriction is intended or implied as to the type of computerized device to which these teachings may be applied. Other suitable devices include: wearable computers, smartphones, tablet computers (the Nexus®, Xoom®, and the iPad®, for example), handheld game consoles, global positioning system (GPS) receivers, personal digital assistants (PDAs), audio- and video-file players (e.g., MP3 players and the iPod®), digital cameras, and e-book readers (e.g., the Kindle® and the Nook®), for example. For purposes of these teachings, a computerized device is any device that comprises a processing element capable of distinguishing between different levels of user input complexity and associating user inputs of different complexity with actions having different sensitivities, which are performed by the device 100.

The terms “sensitivity” and “importance,” as used herein, identify a characteristic used to quantify, at least relatively, different actions that are performed by the computerized device 100. An action having greater sensitivity or importance has a greater potential downside for a user if performed, either purposely and/or inadvertently, as compared to an action with less sensitivity or importance. For example, deleting a system file connected with the operation of the device 100 is an action having greater sensitivity than deleting a data file that is not connected with the operation of the device 100. If the system file is deleted, the downside is that the device 100 may no longer function properly. In a second example, downloading a file from an unverified Internet site is a more sensitive action than downloading a file from a trusted site. The downside of downloading files from unverified sites is that there is a greater chance the files will contain malware (i.e., malicious code).

For some embodiments, the sensitivities of different actions are ranked automatically by the computerized device 100 without the need for user input. For a particular embodiment, a database of quantitative values for the sensitivities of different actions is preprogrammed into the device 100. In a further embodiment, a user has the ability to expand the database of sensitivity values by designating the importance of personal files. Without user input, the device 100 is unable to discern the importance of personal files. A first personal file might be a list of current passwords, whereas a second personal file might be a list of past calendar dates. Where the user designates the first personal file as more important than the second personal file, the device 100 has the ability to assign an action applied to the first file a higher sensitivity relative to the same action applied to the second file. Continuing with the above example, deleting a user's passwords is a more sensitive action than deleting a list of expired calendar dates.

In another embodiment, the user can edit or modify the sensitivity of an action that is already pre-assigned or normally determined by the device. An experienced user that routinely uses a particular action, for example, may wish to decrease the action's assigned sensitivity to reduce the input complexity associated with the action.

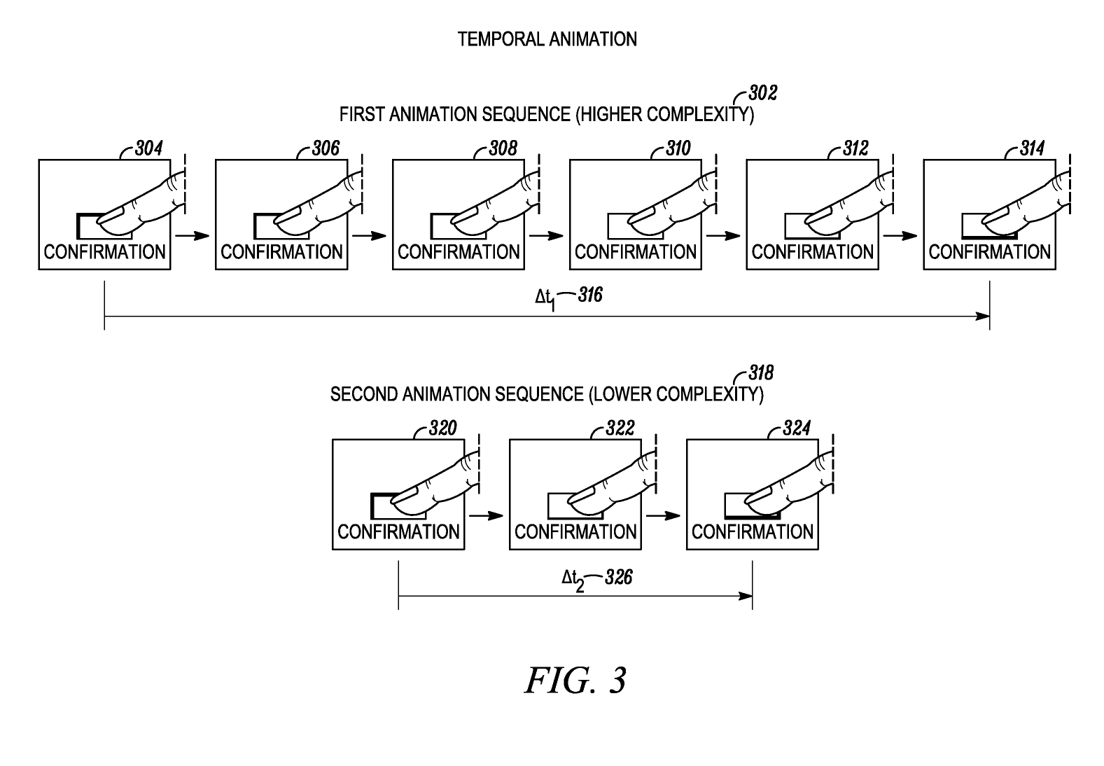

Input complexity, as used herein, is the basis by which different inputs are distinguished from one another and paired with actions having specific sensitivities. For some embodiments, input complexity is gauged by the time duration for which an input is sustained and/or the spatial distance the input covers. For particular embodiments, inputs that are sustained for longer periods of time or inputs that covers larger distances are deemed to have greater complexity relative to inputs that are sustained for shorter durations of time or cover lesser distances. In an embodiment where user input comprises making contact with the touch screen 102, the time duration of the input is the period of time for which contact is maintained. The spatial distance of the input is the distance through which the point of contact is moved during the duration of the input. Specific examples of temporal and spatial inputs, along with their relative complexities, are given below with reference to FIGS. 3-5.

The output interface 102, in this case the touch screen, of device 100 is configured to present a plurality of animation sequences to a user. In an embodiment, an animation sequence is a series of graphical images, frames, or animations that are displayed on the touch screen 102 in a predetermined order to play as a “movie.” Individual animation sequences are coupled to specific user inputs, and as a result, an animation sequence and the user input to which it is coupled are deemed to have the same level or degree, meaning quantitative amount, of complexity, referred to herein as “user input and animation sequence complexity.” The coupled animation sequence and user input, in turn, are both associated (i.e., matched or paired) to one or more actions having a specific sensitivity. In a particular embodiment, coupled user inputs and animation sequences with greater user input and animation sequence complexity are associated with actions having higher sensitivities.

In general, for purposes of these teachings, computerized devices are adapted with functionality in accordance with embodiments of the present disclosure as described in detail below with respect to the remaining figures. “Adapted,” “configured” or “capable of as used herein means that the indicated elements are implemented using one or more (although not all shown) memory devices, interfaces (e.g., user interfaces and network interfaces) and/or processing elements that are operatively coupled. The memory devices, interfaces and/or processing elements, when programmed, form the means for these device elements to implement their desired functionality.

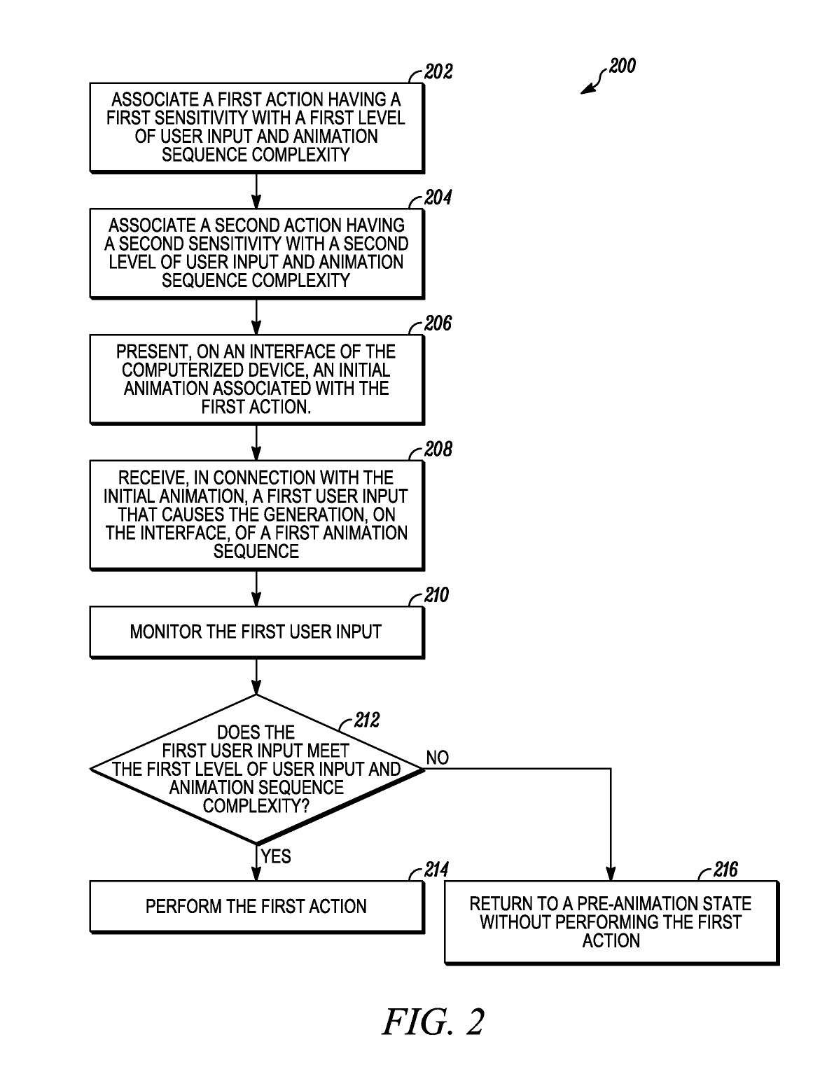

The processing element utilized by the computerized device at 100 may be partially implemented in hardware and, thereby, programmed with software or firmware logic or code for performing functionality described by reference to FIGS. 2-7; and/or the processing element may be completely implemented in hardware, for example, as a state machine or ASIC (application specific integrated circuit). The memory implemented by the computerized device can accommodate the short-term and/or long-term storage of any information needed for the proper functioning of the device 100. The memory may further store software or firmware for programming the processing element with the logic or code needed to perform its functionality.

We turn now to a more detailed description of the functionality of a computerized device, such as the device shown at 100, in accordance with the teachings herein and by reference to the remaining figures. FIG. 2 shows a logical flow diagram 200 illustrating a method by which a first action having a first sensitivity is performed in response to receiving a first user input, with a first level of complexity, that is coupled to a first animation sequence. In particular, at 202, device 100 associates a first action having a first sensitivity with a first level of user input and animation sequence complexity. At 204, the device 100 associates a second action having a second sensitivity with a second level of user input and animation sequence complexity. Utilizing multiple associations allows the device 100 to distinguish between multiple levels of user input complexity and to verify that a particular input complexity is met before an associated action is taken. Soliciting inputs of varying complexities for different actions increases the likelihood that a user will appreciate the greater potential downside of a more sensitive action, and further, that he intends for the action to be performed.

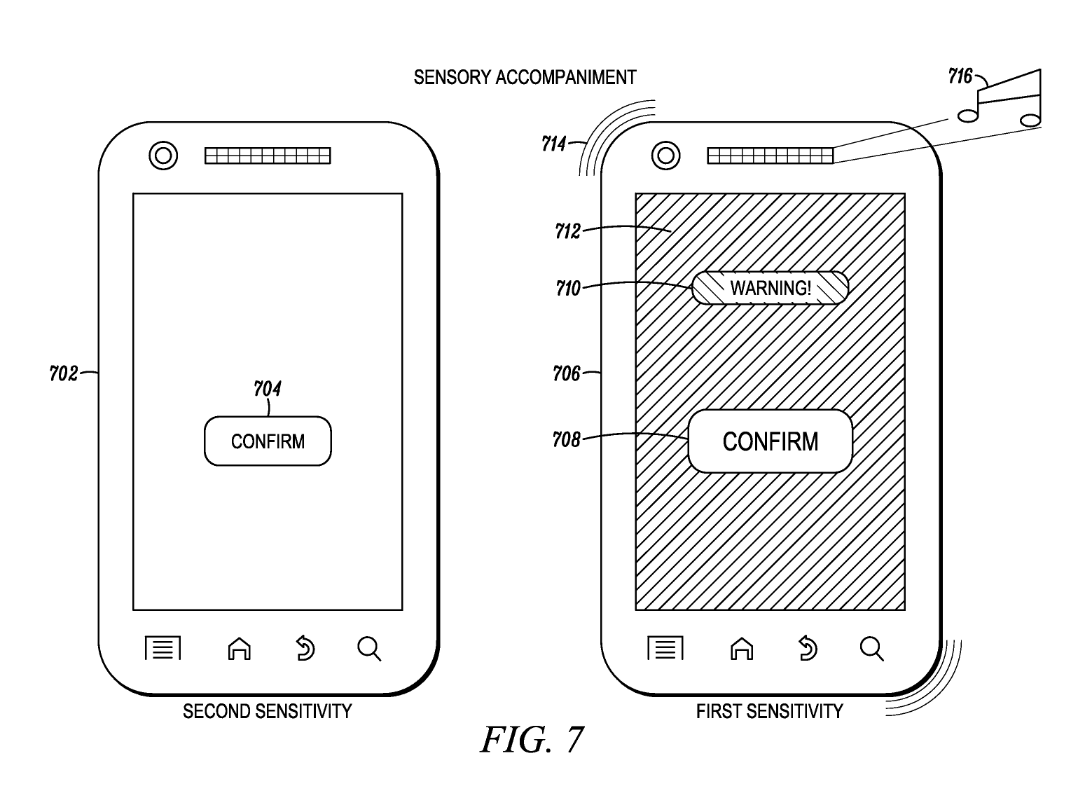

At 206, device 100 presents on its interface 102 an initial animation. In an embodiment, the initial animation is the first of the ordered animation frames that comprise an animation sequence. Here, the initial animation is associated with the first animation sequence, which is, in turn, is associated with the first action. The initial animation is presented when, and as a consequence of, the device 100 receiving an indication that a first action is to be performed. For some embodiments, the indication that the first action is to be performed comes from the user. In other embodiments, the indication is not received from the user, for example, when system or software updates become available. For such embodiments, the first input can serve as a confirmation before the first action is performed. The initial animation provides notice to the user that the device 100 is ready to receive input. A virtual button shown in FIG. 7 at 704 serves as an example of an initial animation. It suggests to the user that he should press the button 704 to confirm the execution of an action, such as an action he has chosen.

At 208, the device 100 receives a first input in connection with the initial animation. The first input causes the generation of a first animation sequence on the output interface 102 of the computerized device 100. For an embodiment, generation of the first animation sequence comprises playing the first animation sequence. For the above example of a virtual button, the first animation sequence comprises the virtual button being depressed. As the first input is sustained, the first animation sequence plays. For example, as the user holds his finger in contact with the touch screen 102, the image of the button changes.

For some embodiments, the first animation sequence continues only if the first user input continues. In additional embodiments, the first animation sequence provides direction, and in some instances also feedback, on how the first input should proceed. For instance, the user moves his finger to “keep up” with the animation as it plays, and/or the animation indicates how the user should move his finger from its present location. The first input is coupled with the first animation sequence, and therefore also with the initial animation, in that there is a correlation between them. As the first animation sequence plays out in a particular way, the first user input tracks with it. This results in the first user input (if performed properly) and the first animation sequence sharing a first level of user input and animation sequence complexity. Greater detail on this aspect of the method 200 is provided below with reference to FIGS. 3-5.

At 210, the computerized device 100 monitors the first user input that accompanies the first animation sequence as it is being presented to determine (212) if the first user input meets the first level of user input and animation sequence complexity. In an embodiment, the device 100 monitors the first user input, employed on a capacitive or resistive touch screen 102, to register when contact is being made with the touch screen 102. If the user maintains the appropriate contact with the touch screen 102, the device continues to play the first animation sequence. However, if, during monitoring the first user input, the device detects that the first user input has ceased, the device will correspondingly discontinue playing the first animation sequence. In this manner, the first animation sequence tracks the first user input. The first animation sequence tracking the first user input, as used herein, means that there is a correlation between the first animation sequence and the first user input.

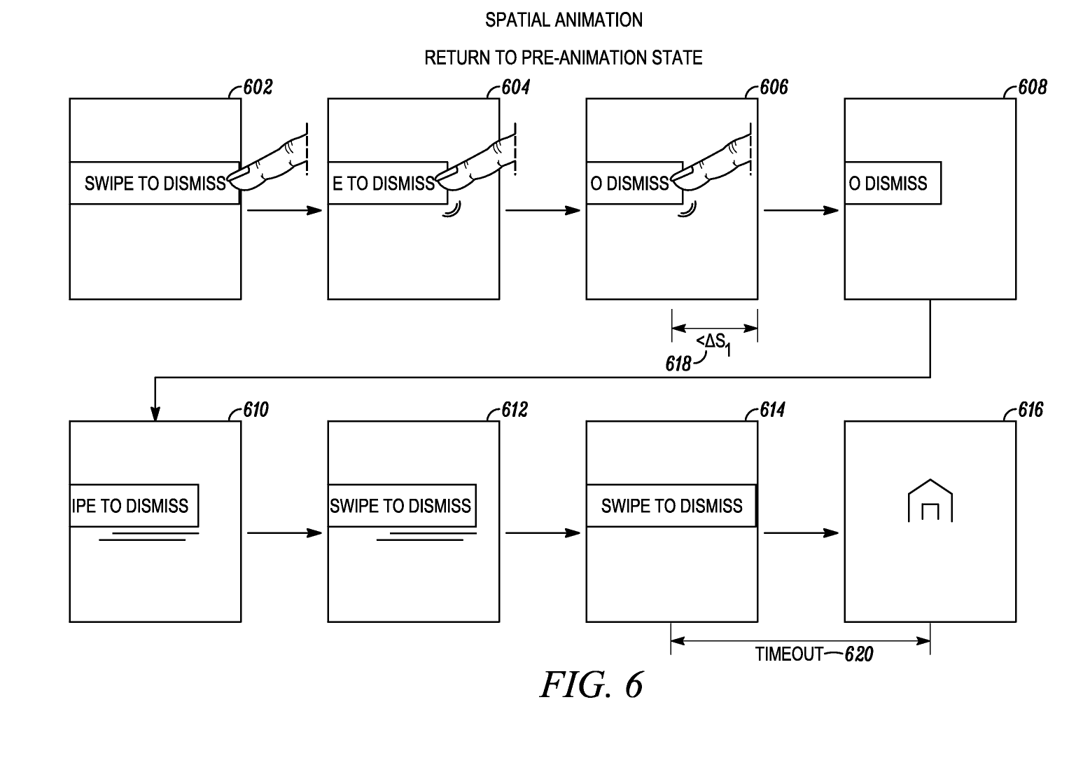

The first user input meets the first level of user input and animation sequence complexity if and when the user maintains sufficient correlation between the first user input he provides and the first animation sequence for the duration (i.e., run time) of the sequence. When the first user input meets the first level of user input and animation sequence complexity, the computerized device 100 performs the first action, at 214. If sufficient correlation is not maintained, the first user input does not meet the first level of user input and animation sequence complexity, and the device 100 returns to a pre-animation state, at 216, without performing the first action, as indicated below by reference to FIG. 6.

FIGS. 3-7 focus on individual aspects of the method 200, specifically, different types of animation sequences, the return to a pre-animation state, and sensory accompaniment. FIG. 3, in particular, shows two temporal animation sequences, a first animation sequence at 302 and a second animation sequence at 318, which have different complexities. The complexity of each animation sequence is based on the duration of the user input associated with it. The animation sequence 302 includes a sequence of animation frames or pictures 304-314, and the animation sequence 318 includes a sequence of frames 320-324. Both animation sequences comprise a three-dimensional (3D) representation of a virtual button being depressed as it is displayed on a touch screen, such as the touch screen displayed in FIG. 1 at 102. In an embodiment, both animation sequences also begin from an identical initial animation, namely the 3D image of the button (e.g., button 704) on the touch screen 102.

Considering the first animation sequence 302, a user makes contact with the touch screen 102 by placing his finger upon the virtual button displayed in the initial animation at 304. This marks the start of the first user input and also begins the first animation sequence 302. As the user holds his finger on the virtual button, the first animation sequence 302 plays (at 304-314), giving the appearance that the 3D button is being pushed into the screen 102. Determining whether the first user input meets the first level of user input and animation sequence complexity, in this case, comprises determining whether the first user input is sustained for a first threshold time. In one embodiment, a duration of the first animation sequence, Δt₁ 316, comprises the first threshold time. Similarly, a duration of the second animation sequence, Δt₂ 326, is used to determine whether a second user input meets a second level of user input and animation sequence complexity.

The second animation sequence 318 is of lower complexity than the first animation sequence 302. Here, the first level of user input and animation sequence complexity being greater than the second level of user input and animation sequence complexity comprises the first level of user input and animation sequence complexity having a greater time duration than the second level of user input and animation sequence complexity. This is reflected in FIG. 3 by the interval Δt₁ 316 being greater than the interval Δt₂ 326 (Δt₂<Δt₁). The second animation sequence 318 presents an image of a button being pushed into the screen more quickly than for the first animation sequence 302. To accomplish this, the second animation sequence 318 can comprise fewer individual frames and/or present its frames at a faster rate as compared to the first animation sequence 302.

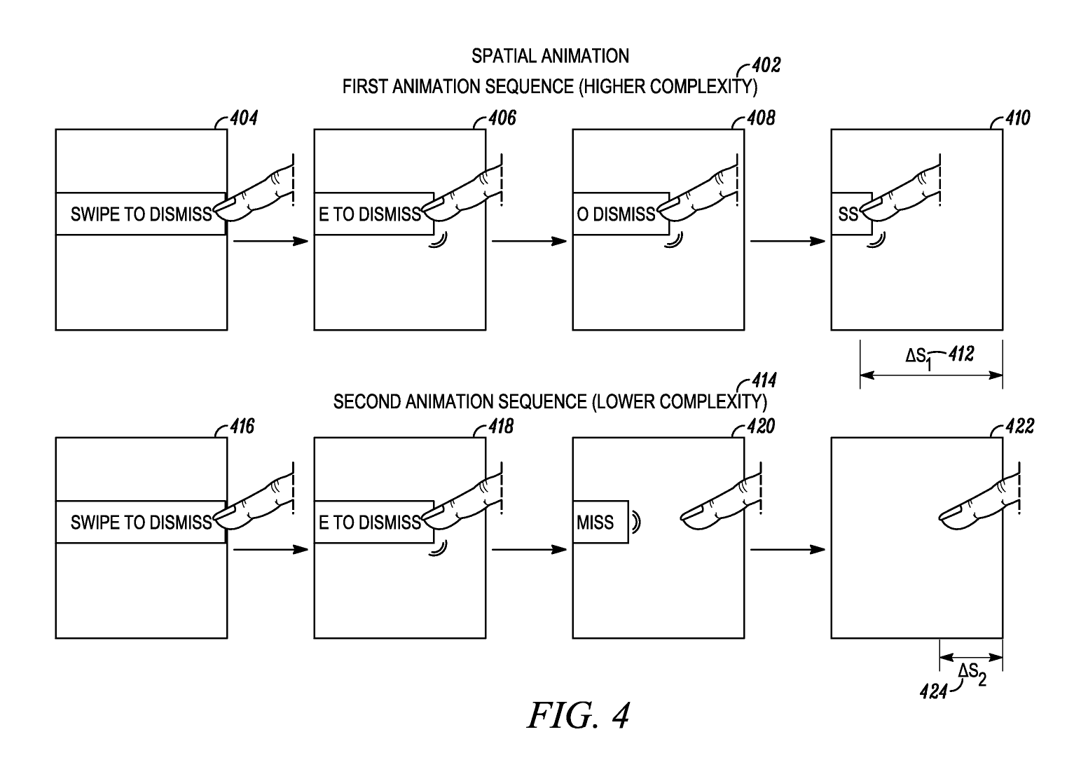

Shown in FIG. 4 are two animation sequences 402 and 414 for which the level of user input and animation sequence complexity is represented by spatial distance Animation sequence 402 is shown with respect to a sequence of snapshots 404-410. Animation sequence 414 is shown with respect to a sequence of snapshots 416-422. In both cases, the user input is correlated with or tracks an animated image of a bar that moves across the touch screen 102. These animations simulate a bar being pushed by the user's finger at the contact point. The distance the user's finger traverses on the screen, in other words how far the contact point moves, determines if the user input meets a specified level of user input and animation sequence complexity. Here, the first level of user input and animation sequence complexity being greater than the second level of user input and animation sequence complexity comprises the first level of user input and animation sequence complexity having a greater spatial distance than the second level of user input and animation sequence complexity. This is made clear by comparing the first animation sequence, shown at 402, against the second animation sequence, shown at 414.

For the first animation sequence 402, which has the higher complexity of the two, the user places his finger on the right edge of the image of the bar in the initial animation at 404. This activates the animation sequence 402, and the bar begins to move across the screen from right to left. For other embodiments, the animated bar will move in different directions. As the right edge of the bar moves at 406 and 408, the user's finger tracks it while touching the screen. Only when the user's finger tracks the bar through a distance greater than or equal to a first threshold distance Δs₁ 412, as shown at 410, does the first user input meet the first level of user input and animation sequence complexity. Thus, the first user input comprises a swipe that traverses a first distance, wherein determining whether the first user input meets the first level of user input and animation sequence complexity comprises determining whether the first distance meets the first threshold distance Δs₁ 412. If the first distance is less than the first threshold distance Δs₁ 412, the first action is not performed.

For the second animation sequence 414, the user need only move his finger through a second distance that meets or exceeds a second threshold distance Δs₂ 424 for the second user input to satisfy the second level of user input and animation sequence complexity. The user places his finger on the initial animation to trigger the second animation sequence 414 at 416 and then moves his finger on the touch screen 102 to track the motion of the sliding animated bar at 418. At 420, the user stops moving his finger but the second animation sequence 414 continues until the bar disappears from the touch screen 102 because the user has moved his finger through a second distance that is equal to or greater than the second threshold distance Δs₂ 424. At this point, the second input achieves the second level of user input and animation sequence complexity, and the second action is performed. In another embodiment, the second animation sequence 414 stops when the user lifts his finger (i.e., breaks contact with the touch screen 102) and the device performs the second action, provided the second level of user input and animation sequence complexity is met.

Because the second threshold distance 424 is less than the first threshold distance 412 (Δs₂<Δs₁), the second level of user input and animation sequence complexity is less than the first level of user input and animation sequence complexity. Therefore, the second animation sequence 414 is associated with actions having a lower sensitivity than actions associated with the first animation sequence 402.

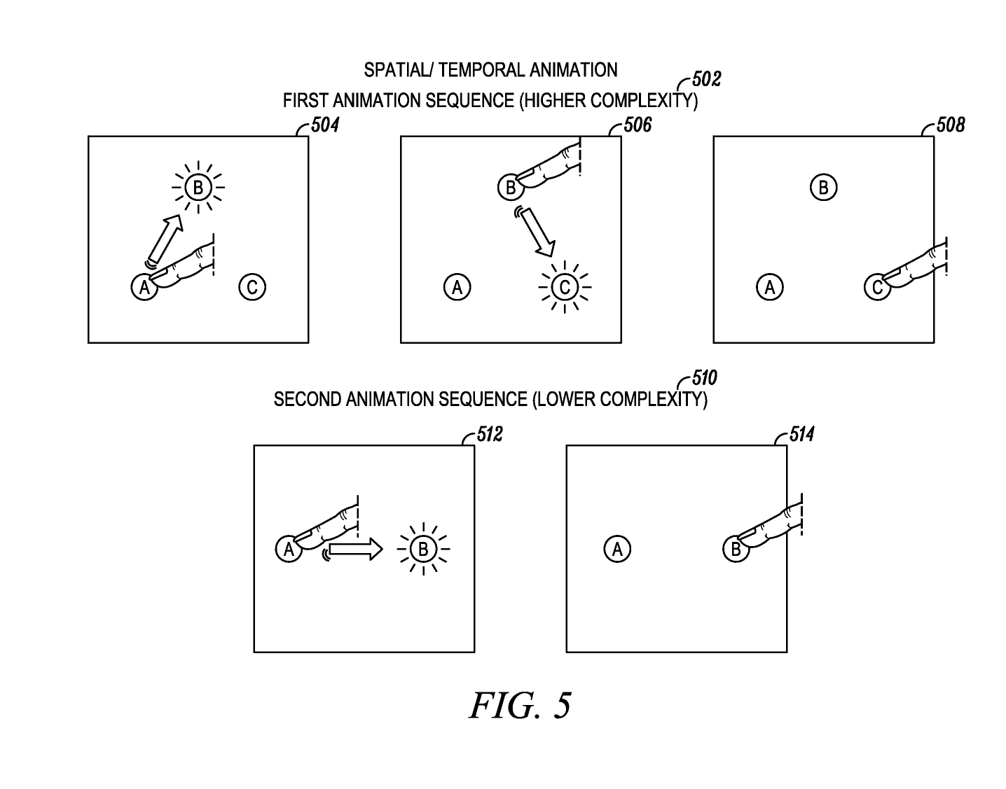

For some embodiments, the first level of user input and animation sequence complexity has a time duration and a spatial distance, and the first level of user input and animation sequence complexity being greater than the second level of user input and animation sequence complexity comprises at least one of: the time duration of the first level of user input and animation sequence complexity being greater than a time duration of the second level of user input and animation sequence complexity; or the spatial distance of the first level of user input and animation sequence complexity being greater than a spatial distance of the second level of user input and animation sequence complexity. A first animation sequence shown at 502 in FIG. 5 represents one such embodiment. A second animation sequence with lower complexity is shown at 510.

Considering the first animation sequence 502, the computerized device 100 presents on its touch screen 102 an initial animation (not shown) that comprises three points (i.e., spatial locations) labeled as “A,” “B” and “C.” The first animation sequence 502 begins at 504 when the user places his finger on point A and the device 100 starts to monitor the first user input. Sensing the user's finger is at point A, the first animation sequence 502 indicates to the user he should move his finger to point B. This is done by momentarily distinguishing point B from the other points (e.g., by making it brighter or making it blink) while displaying an arrow (which may also be animated) that points from point A to point B, as shown at 504. After the device determines (as a result of the monitoring) the user has moved his finger to point B, the first animation sequence 502 displays an arrow pointing from point B to point C, which is now distinguished from points A and B, as shown at 506, prompting the user's next move. When the user's finger arrives (508) at point C, the first user input is determined to have the first level of user input and animation sequence complexity, and the first action is performed.

For the second animation sequence 510, only two points, labeled as “A” and “B,” are displayed in the initial animation (not shown). In response to the initial animation, the user places (512) his finger at point A, which begins the second animation sequence 510. The user then drags his finger to point B as the second animation sequence 510 distinguishes point B from point A and produces an arrow pointing to point B from point A. At 514, the device 100 determines the second input has met the second level of user input and animation sequence complexity and proceeds to perform the second action.

The animation sequences shown in FIG. 5 have a spatial component in that the user's finger covers a spatial distance as it is moved from one labeled point to another. On this basis, the first animation sequence 502 has a higher level of user input and animation sequence complexity because it has an additional labeled point (i.e., point C) as compared with the second animation sequence 510, which has only two labeled points (i.e., point A and point B). Additional embodiments have different numbers and geometric configurations of labeled points, as well as varied distances between them.

An increase in spatial distance for the user input connected with the addition of labeled points to an animation sequence of the type shown in FIG. 5 also leads to an increase in the time duration for the user input. In different embodiments, the level of user input and animation sequence complexity is determined from the spatial distance of the user input, the time duration of the user input, or both. In further embodiments, two animation sequences having the same number of labeled points have different levels of complexity based on the speed at which the user drags his finger from one point to another. By slowing down the animation, the time duration of the user input, and thus its complexity, is increased. In an embodiment, exceeding the speed dictated by the animation results in the computerized device 100 determining that the specific level of user input and animation sequence complexity is not met.

The computerized device 100 returns to a pre-animation state without performing the first action when the first user input fails to meet the first level of user input and animation sequence complexity. In one embodiment, returning the device 100 to the pre-animation state comprises presenting, on the interface 102, the initial animation associated with the first action. FIG. 6 illustrates such an embodiment by showing the individual frames of the first animation sequence 402 when the first user input fails to meet the first level of user input and animation sequence complexity. At 602-606, the user moves his finger with the animated bar as it is displayed on the interface 102 of device 100 as he did at 404-408. Unlike the first user input for the first animation 402 sequence in FIG. 4, however, the user stops moving his finger at a first distance 618 which is less than the first threshold distance Δs₁ 412. After the user lifts his finger from the interface 102 at 608, the animated bar reverses direction and moves (610, 612) back toward the center of the interface 102. At 614, the device 100 returns to the initial animation, which comprises the bar being displayed center-screen. From the initial animation screen 614, the user can again attempt to provide a first user input that meets the first level of user input and animation sequence complexity.

In another embodiment, returning the device to the pre-animation state comprises providing a notification that the first action was not performed. For this embodiment, the interface 102 of device 100 shown at 614 also displays a written notice or additional graphic (not shown), together with the initial animation, alerting the user to the fact that the first action was not performed. In an alternate embodiment, an auditory notice is provided using the speaker 104. For a further embodiment, the initial animation screen shown at 614 “times out” if no additional user input is received. After a timeout period 620, the device 100 returns to its home screen, as shown at 616.

FIG. 7 contrasts an initial animation presented with sensory accompaniment against an initial animation presented without sensory accompaniment. Sensory accompaniment is defined herein as additional output a computerized device presents with an initial animation and/or animation sequence that can be perceived by one or more of a user's senses. This includes making an aspect of the initial animation more noticeable—making a virtual button larger and/or brighter, for example. The purpose of sensory accompaniment is to alert the user to the fact that a sensitive action is about to be performed. For an embodiment, sensory accompaniment comprises at least one of the following: a sound, a vibration, an enhanced color, a visual effect, or force feedback. For a specific embodiment, force feedback is implemented using a volumetric haptic display.

In particular, FIG. 7 shows two views of a computerized device (e.g., device 100) presenting different initial animations associated with different actions having different sensitivities. At 706, device 100 displays an initial animation, comprising a virtual button 708, associated with a first action having a first sensitivity. At 702, device 100 displays an initial animation, comprising a virtual button 704, associated with a second action having a second sensitivity. The initial animation shown at 706 is presented with sensory accompaniment, whereas the initial animation shown at 702 is presented without sensory accompaniment.

More specifically, the initial animation shown at 706 is presented with five forms of sensory accompaniment that distinguish it from the initial animation 702. First, the virtual button 708 is made more noticeable by appearing larger and having a greater font size than the virtual button 704. Second, the touch screen 102 is dimmed at 712 to provide better contrast and to highlight the virtual button 708. Third, a warning banner is presented at 710 to provide the user with clear notice that the considered first action is highly sensitive. Fourth, the device 100 vibrates, as indicated at 714, to provide a felt indication of the first action's level of sensitivity. Fifth, the device produces an audible alert tone from its internal speaker 104, as indicated at 716.

Accordingly, for some embodiments, the computerized device 100 presents a sensory accompaniment with the initial animation associated with a first action, which is not presented with an initial animation associated with a second action of lower sensitivity than the first. For other embodiments, device 100 presents multiple forms of sensory accompaniment with the initial animation associated with a first action, which are not presented with the initial animation associated with the second action. FIG. 7 captures such an embodiment where the initial animation associated with a second action, shown at 702, is presented without sensory accompaniment.

There are also embodiments in which the initial animations 702 and 706 are presented with the same sensory accompaniment. For one such embodiment, the device 100 presents a sensory accompaniment with greater prominence for the initial animation associated with the first action than for an initial animation associated with the second action. A first example comprises the initial animation at 702 presented with a dimmed screen that is only fractionally as dark as the screen shown at 712. A second example comprises the initial animation at 702 presented with an audible tone that is of a lower decibel level than the tone indicated at 716.

Implementing the teachings presented herein allow for varied types of input having different levels of complexity to be associated with actions, performed by a computerized device, having different sensitivities. This is accomplished through the use of different animation sequences, and in some instances, sensory accompaniment, that are coupled with the actions. Each animation sequence, having a particular complexity, is coupled to one or more actions identified as having a particular level of sensitivity. The computerized device performs an identified action when it receives user input that meets the level of complexity of the animation sequence coupled to that action.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by a computerized device for receiving input of varying levels of complexity to perform actions having different sensitivities, the method comprising:
associating a first action having a first sensitivity with a first level of user input and animation sequence complexity;
associating a second action having a second sensitivity with a second level of user input and animation sequence complexity, wherein the second sensitivity is lower than the first sensitivity, and the first level of user input and animation sequence complexity is greater than the second level of user input and animation sequence complexity;
presenting, on an interface of the computerized device, an initial animation associated with the first action;
receiving, in connection with the initial animation, a first user input that causes the generation, on the interface, of a first animation sequence that tracks the first user input, wherein the first animation sequence begins with the initial animation; and
monitoring the first user input to determine whether the first user input meets the first level of user input and animation sequence complexity.

2. The method of claim 1 further comprising performing the first action when the first user input meets the first level of user input and animation sequence complexity.

3. The method of claim 1, wherein the first level of user input and animation sequence complexity being greater than the second level of user input and animation sequence complexity comprises the first level of user input and animation sequence complexity having a greater time duration than the second level of user input and animation sequence complexity.

4. The method of claim 3, wherein determining whether the first user input meets the first level of user input and animation sequence complexity comprises determining whether the first user input is sustained for a first threshold time.

5. The method of claim 4, wherein a duration of the first animation sequence comprises the first threshold time.

6. The method of claim 5, wherein the first animation sequence comprises a virtual button being depressed.

7. The method of claim 1, wherein the first level of user input and animation sequence complexity being greater than the second level of user input and animation sequence complexity comprises the first level of user input and animation sequence complexity having a greater spatial distance than the second level of user input and animation sequence complexity.

8. The method of claim 7, wherein the first user input comprises a swipe that traverses a first distance, and wherein determining whether the first user input meets the first level of user input and animation sequence complexity comprises determining whether the first distance meets a first threshold distance.

9. The method of claim 1 further comprising returning the computerized device to a pre-animation state without performing the first action when the first user input fails to meet the first level of user input and animation sequence complexity.

10. The method of claim 9, wherein returning the device to the pre-animation state comprises presenting, on the interface, the initial animation associated with the first action.

11. The method of claim 9, wherein returning the device to the pre-animation state comprises providing a notification that the first action was not performed.

12. The method of claim 1, wherein the first level of user input and animation sequence complexity has a time duration and a spatial distance, and wherein the first level of user input and animation sequence complexity being greater than the second level of user input and animation sequence complexity comprises at least one of: the time duration of the first level of user input and animation sequence complexity being greater than a time duration of the second level of user input and animation sequence complexity; or the spatial distance of the first level of user input and animation sequence complexity being greater than a spatial distance of the second level of user input and animation sequence complexity.

13. The method of claim 1 further comprising presenting a sensory accompaniment with the initial animation, which is not presented with an initial animation associated with the second action.

14. The method of claim 1 further comprising presenting a sensory accompaniment with greater prominence for the initial animation associated with the first action than for an initial animation associated with the second action.

15. The method of claim 14, wherein the sensory accompaniment comprises at least one of the following:
a sound;
a vibration;
an enhanced color;
a visual effect; or force feedback.

16. A method performed by a computerized device for associating actions having different levels of importance with input having varying degrees of complexity, the method comprising:
associating a first action having a first level of importance with a first degree of user input and animation sequence complexity;
associating a second action having a second level of importance with a second degree of user input and animation sequence complexity, wherein the first level of importance is greater than the second level of importance, and the first degree of user input and animation sequence complexity is greater than the second degree of user input and animation sequence complexity;
presenting, on an interface of the computerized device, an initial animation associated with the first action;
receiving, in connection with the initial animation, a first user input that causes a first animation sequence to begin from the initial animation;
monitoring, as the first animation sequence is presented, the first user input to determine whether the first user input satisfies the first degree of user input and animation sequence complexity;
confirming that the first user input satisfies the first degree of user input and animation sequence complexity, and responsively performing the first action.

17. The method of claim 16, wherein confirming that the first user input satisfies the first degree of user input and animation sequence complexity comprises at least one of:
confirming that the first user input is sustained for a first threshold time that is greater than a second threshold time used to confirm that a second user input satisfies the second degree of user input and animation sequence complexity; or
confirming that the first user input traverses a distance greater than a first threshold distance that exceeds a second threshold distance used to confirm that a second user input satisfies the second degree of user input and animation sequence complexity.

18. An apparatus for accepting inputs with different relative complexities to perform tasks with different relative sensitivities, the apparatus comprising:
a processing element configured to:
associate a first action having a first sensitivity with a first level of user input and animation sequence complexity;
associate a second action having a second sensitivity with a second level of user input and animation sequence complexity, wherein the second sensitivity is lower than the first sensitivity, and the first level of user input and animation sequence complexity is greater than the second level of user input and animation sequence complexity; and
monitor a first user input to determine whether the first user input satisfies the first level of user input and animation sequence complexity;
an output interface coupled to the processing element and configured to display an initial animation and a first animation sequence associated with the first action; and
an input interface coupled to the processing element and the output interface, wherein the input interface is configured to receive, in connection with the initial animation, a first user input that causes the generation, on the interface, of the first animation sequence that tracks the first user input, wherein the first animation sequence begins with the initial animation.

19. The apparatus of claim 18, wherein the output interface and the input interface comprise a touch screen.

20. The apparatus of claim 18, wherein the output interface is further configured to present a first sensory accompaniment with the first animation sequence, wherein the first sensory accompaniment has a greater prominence than a second sensory accompaniment presented with a second animation sequence associated with the second action, and wherein the processing element is further configured to perform the first action upon determining that the first user input satisfies the first level of user input and animation sequence complexity.
